(19) United States
(12) Patent Application Publication
(10) Pub. No.: US 2017/0134785 A1
(43) Pub. Date: May 11, 2017

(54) TELEVISION SYSTEM INCLUDING AUTOMATIC LIGHT CONTROL BASED ON METADATA ASSOCIATED WITH A RECEIVED SIGNAL

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 14/936,862

(22) Filed: Nov. 10, 2015

(51) Int. Cl. H04N 21/41; H04N 21/4363; H04N 21/436; H04N 21/435

(52) U.S. Cl. CPC H04N 21/4131; H04N 21/435; H04N 21/43637; H04N 21/43615

(57) ABSTRACT

A television includes an input device configured and disposed to receive a signal stream including a video portion, and a metadata portion. A video output device is operatively connected to the input device. The video output device is configured and disposed to display the video portion of the signal stream. A metadata reader is operatively connected to the input device. The metadata reader is configured and disposed to read metadata associated with the metadata portion of the signal stream. A lighting control unit is operatively connected to the metadata reader. The lighting control unit is configured and disposed to selectively, automatically control one or more light fixtures based on the metadata associated with the metadata portion of the signal stream.

### BACKGROUND

The present invention relates to the art of televisions and, more specifically, to a television that automatically controls lights based on a received signal.

Televisions are ubiquitous. An average household includes one or more televisions. In many cases, one television is arranged in a central area, such as a family room, a den, a man cave, and the like, and is employed to screen television shows, movies and the like. Such televisions are often paired with a home entertainment system that provides audible effects such as surround sound, and may also include a video player, such as a DVD, CD-ROM, Blu-ray Disk™ (BRD) and the like. In addition to providing audible effects, consumers may desire to enhance a viewing experience by adding lighting effects. Currently, controlling lights based on movie content requires the use of specialized receiving devices that may be coupled to a home automation controller.

### SUMMARY

According to an exemplary embodiment, a television includes an input device configured and disposed to receive a signal stream including a video portion, and a metadata portion. A video output device is operatively connected to the input device. The video output device is configured and disposed to display the video portion of the signal stream. A metadata reader is operatively connected to the input device. The metadata reader is configured and disposed to read metadata associated with the metadata portion of the signal stream. A lighting control unit is operatively connected to the metadata reader. The lighting control unit is configured and disposed to selectively, automatically control one or more light fixtures based on the metadata associated with the metadata portion of the signal stream.

According to another aspect of an exemplary embodiment, a method of selectively, automatically, controlling lights through a television includes receiving, at the television, a signal stream including a video portion and a metadata portion, displaying the video portion on a display at the television, reading, in the television, the metadata portion of the signal stream, and controlling, through the television, at least one light fixture based on the metadata portion of the signal stream.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a television including a control system having a lighting control unit, in accordance with an exemplary embodiment;

FIG. 2 is a block diagram depicting the control system of FIG. 1; and

FIG. 3 is a flow diagram illustrating a method of controlling lights through a television, in accordance with an exemplary embodiment.

### DETAILED DESCRIPTION

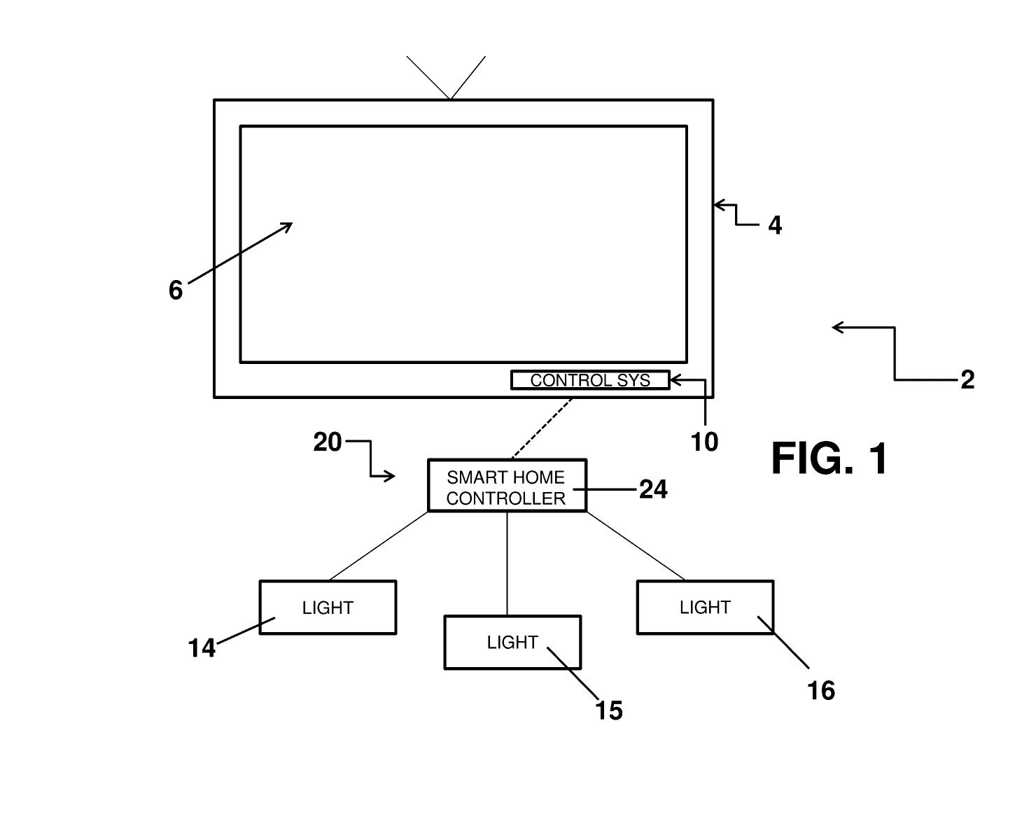

With reference now to FIG. 1, a television, in accordance with an exemplary embodiment, is indicated generally at 2. Television 2 includes a body 4 that supports a display 6. Display 6 may take on a variety of forms including cathode ray tubes (CRT) displays, light emitting diode (LED) displays, liquid crystal displays (LCD), organic light emitting diode (OLED) displays, and the like. Television 2 also includes a control system 10 which, in addition to controlling subject matter presented on display 6, may also control one or more light fixtures 14-16, as will be detailed more fully below. It should be understood that the number, type, location, and arrangement of light fixtures 14-16 may vary. In the exemplary embodiment shown, light fixtures 14-16 may be connected to a light fixture controller 20. Light fixture controller 20 may take on a variety of forms. For example, light fixture controller 20 may take the form of a smart home controller 24 that may be programmed to automatically control a variety of in-home accessories including shades, alarms, appliances, audio, and the like.

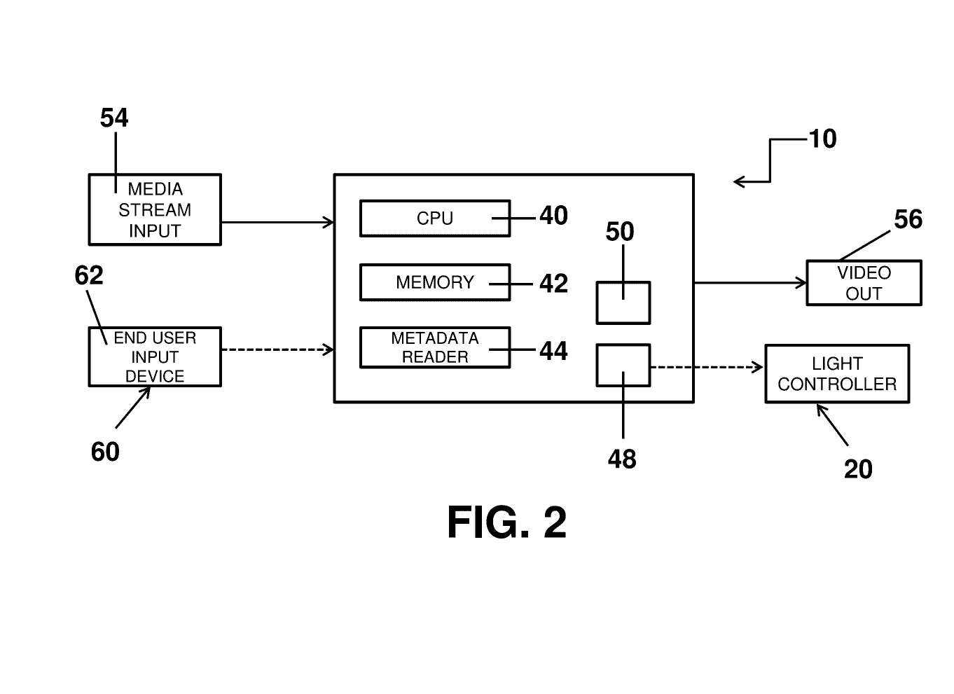

Reference will now follow to FIG. 2 in describing exemplary details of control system 10. It should be understood that in addition to the described details/functions, control system 10 may include additional capabilities. Further, the number, location, and configuration of components may vary. Control system 10 may include a central processing unit (CPU) 40 and a non-volatile memory 42. In accordance with an aspect of an exemplary embodiment, control system 10 includes a metadata reader 44 that may read a metadata portion of a signal stream passed to television 2. Control system 10 includes a lighting control unit 48 that may selectively, automatically, activate light fixtures 14-16 through light fixture controller 20 based on received metadata, as will be detailed more fully below. Additionally, control system 10 may include a wireless transmitter 50 that communicates with light fixture controller 20. Wireless transmitter 50 may employ a variety of techniques for communicating with light fixture controller 20, including transmitting various radio signals such as Bluetooth® signals.

In accordance with an aspect of an exemplary embodiment, control system 10 is operatively connected with a media stream input device 54. Media stream input device 54 may take on a variety of forms. For example, media stream input device 54 may receive a remote signal or media stream from a media provider. Thus, media stream input device 54 may constitute a cable connector that receives a media signal stream from a cable provider. Media stream input device 54 may also constitute a satellite connector that receives a signal or media stream through a satellite dish. Further, media stream input device 54 may receive signals passed through the Internet that may be streamed live or stored in non-volatile memory 42. Media stream input device 54 may also receive a local signal stream from a DVD player, Blu-ray™ disc player, DVR player, and the like. Regardless of the source, the media stream passing into media stream input device 54 includes a video content and a metadata portion. The video content portion is passed through a video output device 56 and presented as images, and the like, on display 6. The metadata portion may contain instructions relating to the images, and the like, being presented on display 6.

In accordance with an aspect of an exemplary embodiment, television 2 may also include a user input device 60. User input device 60 may take the form of a remote control 62 that may communicate wirelessly with control system 10. User input device 60 may also take the form a keypad (not shown) mounted to body 4. Further, user input device 60 may constitute a smart phone or other computing device (also not shown) that may communicate with control system 10 either directly, or through a stored application. User input device 60 may provide a conduit that allows a user to establish one or more rules for controlling one or more of light fixtures 14-16 through television 2. A user may establish rules that instruct lighting control unit 48 to control light fixtures 14-16 to mimic images presented on display 6.

For example, if so indicated by the metadata, light fixtures 14-16 may be dimmed if a graveyard scene is being depicted; light fixtures 14-16 may be brightened to mimic a sunny day; light fixtures 14-16 may be flashed on and off to mimic lightning. The type and level of control may vary. Further, lighting control unit 48 may simply control lights based on default or pre-set rules. Regardless of type, user input and/or default, the rules may be stored in non-volatile memory 42. Further, based on the rules, television 2 may be taught when, how, and how many of light fixtures 14-16 may be controlled for a given metadata.

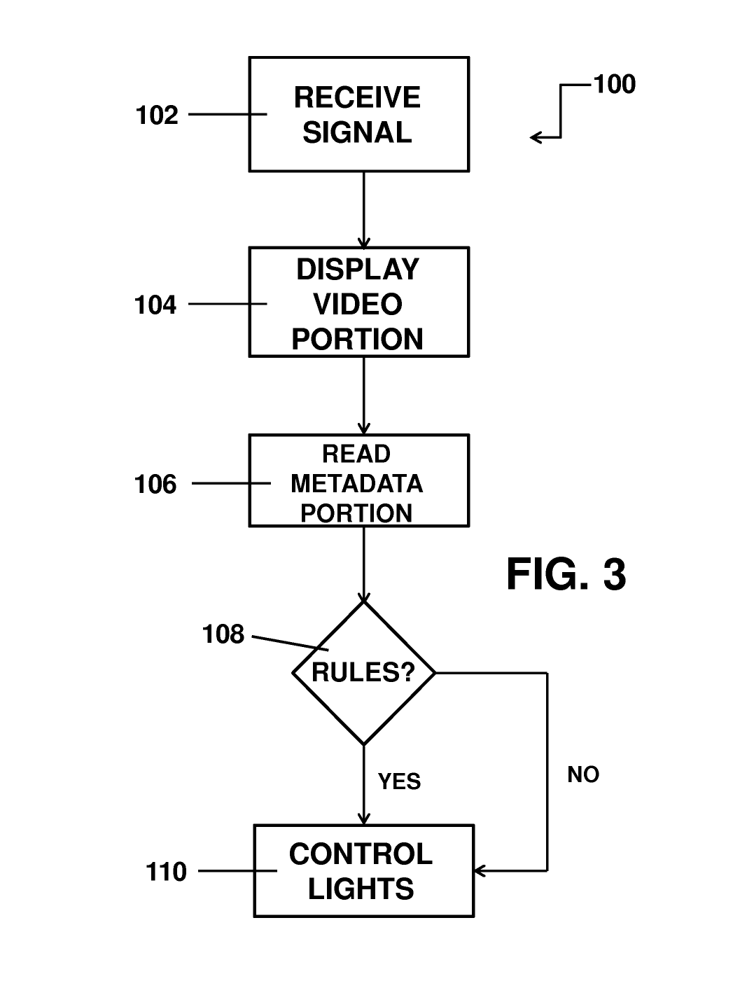

Reference will now follow to FIG. 3 in describing a method 100 of controlling light fixtures 14-16 through television 2. Initially, a signal stream including a video portion and a metadata portion is received through media stream input device 54 in block 102. The video portion is passed through video output device 56 and presented as images on display 6 in block 104. In block 106, the metadata portion of the signal stream is read by metadata reader 44. In block 108 a determination is made whether any user defined rules exist. If rules exist, lighting control unit 48 controls one or more of light fixtures 14-16 through light fixture controller 20 via wireless transmitter 50 in block 110. If no user defined rules exist, lighting control unit 48 controls one or more of light fixtures 14-16 through light fixture controller 20 based on default or factory settings in block 110.

At this point it should be understood that exemplary embodiments describe a television that directly controls light fixtures in, for example, a dwelling, based on received metadata. The television itself decides, based on one or more user defined rules, how, when, and how many lights to control. The television reads metadata associated with a media stream and controls lighting to establish an environment that mimics and/or compliments images displayed on the screen. In this manner, the television itself may enhance an overall viewing experience for a user. Further, in contrast to existing systems that require multiple components, connections, controls and the like, the present invention allows a user to establish a theater-like atmosphere in his home with a single component that interfaces with existing lighting.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A television comprising:
an input device configured and disposed to receive a signal stream including a video portion, and a metadata portion;
a video output device operatively connected to the input device, the video output device being configured and disposed to display the video portion of the signal stream;
a metadata reader operatively connected to the input device, the metadata reader being configured and disposed to read metadata associated with the metadata portion of the signal stream;
a memory operatively connected to the lighting control unit, the memory being configured and disposed to store one or more end user defined lighting control rules establishing a number of devices to be activated and when devices are activated;
an end user input device operatively connected to the lighting control unit, the end user input device being configured and disposed to establish the one or more end user defined lighting control rules in the memory; and
a lighting control unit operatively connected to the metadata reader, the lighting control unit being configured and disposed to selectively, automatically control one or more light fixtures based on the metadata associated with the metadata portion of the signal stream and the end user defined rules.

2. The television according to claim 1, further comprising: a wireless transmitter operatively connected to the lighting control unit, the wireless transmitter being configured and disposed to wirelessly communicate lighting control signals to the one or more light fixtures.

3. The television according to claim 2, wherein the wireless transmitter comprises a short wave length, Ultra High Frequency (UHF) transmitter.

4. (canceled)

5. (canceled)

6. The television according to claim 1, wherein the user input device is wirelessly connected to the lighting control unit.

7. A method of selectively, automatically, controlling lights through a television, the method comprising:
receiving, at the television, a signal stream including a video portion and a metadata portion;
displaying the video portion on a display at the television;
reading, in the television, the metadata portion of the signal stream;
establishing one or more end user defined light control rules in the television, the user defined rules establishing a number of devices to be activated and when devices are activated; and
controlling, through the television, at least one light fixture based on the metadata portion of the signal stream and the end user defined rules.

8. The method of claim 7, wherein controlling, through the television, the at least one light fixture includes wirelessly communicating with a light fixture controller.

9. The method of claim 8, wherein wirelessly communicating with the light fixture controller includes communicating with a smart home controller operatively connected with the at least one light fixture.

10. The method of claim 8, wherein wirelessly communicating with the light fixture controller includes transmitting a short wave length, Ultra High Frequency (UHF) signal from the television to the light fixture controller.

11. (canceled)

12. The method of claim 8, wherein establishing the one or more end user light control rules includes communicating with the television through an end user input device.

13. The method of claim 8, wherein establishing the one or more end user defined light control rules includes storing the one or more light control rules in a non-volatile memory arranged in the television.

14. The method of claim 12, wherein communicating with the television through the user input device includes wirelessly communicating with the television through the user input device.

15. The method of claim 7, wherein receiving, at the television, the signal stream includes receiving a remote media stream.

16. The method of claim 7, wherein receiving, at the television, the signal stream includes receiving a local media stream.

17. The method of claim 16, wherein receiving, at the television, the local media stream includes receiving one of a DVD media stream and a high definition digital optical disc storage format media stream.
